(19) United States
(12) Patent Application Publication
(10) Pub. No.: US 2004/0247634 A1
(43) Pub. Date: Dec. 9, 2004

(54) Treatment of parasitic disease

(76) Inventors: Serge R Martinod, Groton, CT (US); Malcolm Brandon, Bulleen (AU)

Correspondence Address: MORGAN LEWIS & BOCKIUS LLP, 1111 PENNSYLVANIA AVENUE NW, WASHINGTON, DC, 20004, US

(21) Appl. No.: 10/482,058

(22) PCT Filed: Jul. 1, 2002
(86) PCT No.: PCT/AU02/00867

(30) Foreign Application Priority Data
Jul. 4, 2001 (AU) PR 6105

(51) Int. Cl. A01N 25/00

(52) U.S. Cl. 424/405

(57) ABSTRACT

The use of an anti-parasitic agent in a sustained form in the treatment of ectoparasitic infections.

The present invention relates to a method of treatment of parasitic diseases, including external (ecto-) and internal (endo-) parasites and to a sustained release pharmaceutical composition for such treatment. More specifically, the present invention relates to the use of a sustained release pharmaceutical composition which provides a significant increase in the bio-availability of the pharmaceutical composition with a corresponding increase in the blood levels of the pharmaceutical agent.

Parasitic diseases are of particular concern in domestic and farm animals, in particular cattle, sheep, pigs, dogs, cats, rats, mice, birds and fish. Numerous forms of treatment are known including oral tablets, pour-ons, injectables and the like. However, many of the known treatments suffer from the fact that exposure to an infected environment leads to a high level of re-infection as soon as the effect of the treatment wears off.

In the case of pour-on formulations, their use is characterised by high levels of wastage and pollution of the environment with often toxic chemicals.

For example, a particularly useful anti-parasitic agent is ivermectin. This product first became available in an injectable formulation, and later as a pour-on. However, both methods of drug administration require animals to be treated on several occasions. For example, once at the start of grazing and again about six weeks later. In addition, drug levels in the blood are high immediately after administration, but drop substantially after about four weeks. This often results in re-infection developing within six to eight weeks after the second treatment.

However, in addition, the use of ivermectin is not indicated for the treatment of parasitic infestations for smaller animals with the exception of heartworm, particularly cats and dogs, as the high levels required using the conventional methods of application named above to generate protection may be toxic, even lethal, to such animals.

Accordingly, where a disease indication requires the achievement of a high threshold blood plasma level and/or requires the delivery of multiple pharmaceuticals and/or requires sustained release to be continued over an extended period at high levels, the drug delivery systems known in the prior art generally exhibit insufficient drug carrying capacity.

Whilst it is theoretically possible to increase the amount of active delivered by increasing the size of the drug delivery systems in one or more dimensions (e.g. length or diameter), this may not achieve the anticipated result, e.g. as this may lead to “dose dumping” which may be harmful or even lethal to the animal to be treated. Alternatively the large size of the apparatus may prevent its use even with relatively large animals, in particular cattle.

For example, such drug delivery implants may be placed subcutaneously in the ear of an animal. This may be physically impossible where the size of the implant becomes too large.

Further, it has been found that use of multiple implants does not provide the required threshold blood level of pharmaceutical required to successfully treat the disease indication to be treated. This also is limiting due to the total bulk of the implants used.

It is, accordingly, an object of the present invention to overcome or at least alleviate one or more of the difficulties and deficiencies related to the prior art.

Accordingly, in a first aspect, the present invention provides for use of an anti-parasitic agent in a sustained release form, in the treatment of external parasites.

The anti-parasitic agent may include a macrocyclic lactone, for example ivermectin, moxidectin, eprinomectin, doramectin, an insect growth regulator, or mixtures thereof.

The anti-parasitic agent may be used in the treatment of any and all animals, including domestic and farm animals, including sheep, cattle, horses, pigs, goats, dogs, cats, ferrets, rodents, including mice and rats, birds, including chicken, geese and turkeys, marsupials, fish, primates and reptiles.

It has surprisingly been found that use of an anti-parasitic agent, e.g. ivermectin, in a sustained release (i.e. solid) form permits the achievement of ectoparasitic, and optionally endoparasitic protection to animals, without reaching harmful or toxic levels.

Accordingly, in a further aspect of the present invention, there is provided a method of treating parasitic diseases in animals, which method includes

administering to an animal a prophylactically or therapeutically effective, but non-toxic, amount of an anti-parasitic agent in a sustained release form.

The anti-parasitic agent may include a macrocyclic lactone, as described above.

Preferably the parasitic disease to be treated may include an external (ecto-) parasitic infestation, for example fleas, ticks, mites, lice and the like.

In a particularly preferred form, the method may provide for the concomitant treatment of internal (endo-) parasitic infestations including worms, e.g. heartworm.

Accordingly, in a more preferred aspect, the present invention provides for use of an anti-parasitic agent in a sustained release form in the concomitant treatment of external and internal parasites.

For example, where the anti-parasitic agent is ivermectin, the present invention provides for the concomitant treatment of internal parasites (including worms, e.g. heartworm, roundworms) and external parasites (including fleas, ticks and mites) in animals, including domestic and farm animals including in particular cats and dogs.

The anti-parasitic agent may be provided in a sustained release delivery apparatus including a plurality of sustained release mini-implants or pellets;

each mini implant or pellet including

an anti-parasitic composition including

at least one anti-parasitic agent;

a carrier therefor; and optionally

a sustained release support material; the anti-parasitic composition carried in or on the sustained release support material, when present;

each implant being of insufficient size individually to provide a predetermined desired threshold blood level of anti-parasitic active for treatment of a selected disease indication.

Preferably each mini-implant includes

a pharmaceutical active-containing inner layer; and

a water-impermeable outer layer.

More preferably each mini-implant takes the form of an extruded rod bearing a water-impermeable coating thereover.

In a further preferred form the plurality of sustained release mini-implants or pellets in combination may provide a blood level of pharmaceutical active at least equal to a predetermined threshold for an extended period, e.g. of approximately 1 to 24, preferably 1 to 4 weeks for ivermectin active.

In one embodiment, the plurality of sustained release mini-implants or pellets may be of two or more different sizes and provides for the concomitant treatment of ectoparasites and endoparasites.

The mini-implants or pellets may be provided in a first size which provides a blood level of pharmaceutical active of approximately 1.25 to 3 times the desired threshold blood level for an extended, though relatively short, period, e.g. of approximately 1 to 4 weeks, and in a second size which provides a blood level at or near the desired threshold blood level over a longer time period, e.g. of approximately 4 to 52 weeks.

In a particular preferred form, the present invention provides a method of treating fleas in animals, which method includes

administering to an animal a prophylactically or therapeutically effective, but non-toxic amount of an anti-parasitic agent, preferably a macrocyclic lactone, in a sustained release form.

The animals to be treated preferably include cats, dogs, ferrets and rodents.

The sustained release form utilised in the present invention may include a sustained release apparatus.

Accordingly the present invention in this form provides a method for the therapeutic or prophylactic treatment of a parasitic condition in an animal (including a human) requiring such treatment, which method includes administering to the animal a sustained release delivery apparatus including a plurality of sustained release mini-implants or pellets;

each mini implant or pellet including

an anti-parasitic composition including

at least one anti-parasitic agent;

a carrier therefor; and optionally

a sustained release support material; the anti-parasitic composition carried in or on the sustained release support material, when present;

each implant being of insufficient size individually to provide a predetermined desired threshold blood level of anti-parasitic active for treatment of a selected disease indication; and

administering the sustained release delivery apparatus to the animal to be treated.

Applicants have surprisingly found that the threshold blood level of the anti-parasitic agent required to treat external, and optionally internal parasites, may be achieved utilising a series of mini-implants or pellets which individually may be of insufficient or no value in treating the disease.

Preferably the sustained release apparatus may provide approximately zero order release of pharmaceutical active.

In a further preferred form, each mini-implant includes

a pharmaceutical active-containing inner layer; and

a water impermeable outer layer.

More preferably, each mini-implant takes the form of an extruded rod bearing a water-impermeable coating thereover.

In a particularly preferred embodiment, the mini-implants or pellets are provided in at least two different sizes and provides for the concomitant treatment of ectoparasites and endoparasites.

The mini-implants or pellets are provided

in a first size which provides a blood level of pharmaceutical active of approximately 1.25 to 3 times the desired threshold blood level for a first relatively short time period; and

in a second size which provides a blood level of pharmaceutical active at or near the desired threshold blood level for a second longer time period.

In a still further preferred form, the sustained release apparatus may be provided as a sustained release kit. In this embodiment, the method according to the present invention includes

providing a sustained release kit including

a plurality of sustained release mini implants or pellets packaged for delivery in a single treatment;

each mini-implant or pellet including

an anti-parasitic composition including

at least one pharmaceutically active component including an anti-parasitic agent;

a carrier therefor; and optionally

a sustained release support material; the anti-parasitic composition carried in or on the sustained release support material;

each implant being of insufficient size individually to provide a predetermined desired threshold blood level of anti-parasitic agent for treatment of external parasites; and

administering the mini implants or pellets in a single treatment.

Optionally the sustained release kit further includes a sustained release delivery apparatus.

For example, in veterinary applications, an injector instrument for subcutaneous delivery of standard size pellets may be used as the sustained release delivery apparatus.

The multiple mini-pellets may be provided in a single cartridge for use in a standard injector instrument which in turn disperse as individual mini-pellets within the body of the animal to be treated.

In a further preferred form of the present invention, the plurality of sustained release implants may be provided in a biodegradable sheath. The biodegradable sheath may be formed of a water-soluble material.

The water-soluble material utilised in the biodegradable sheath may be selected from one or more of the water-soluble substances described below.

Each sustained release mini-pellet according to the present invention may be biodegradable.

Each sustained release mini-pellet according to the present invention may be of the covered rod or matrix type. A rod-like shape is preferred.

For example each sustained release mini-pellet may be approximately 0.1 to 0.5 times, preferably approximately 0.20 to 0.25 times, the length of a single rod shaped implant, capable of providing the desired threshold blood level of anti-parasitic agent.

For example, in veterinary applications, a typical cattle implant is the product sold under the trade designation “Revalor”, and containing as pharmaceutical actives trembolone acetate and estradiol. This implant has the dimensions 4 mm×4 mm. The equivalent implant according to the present invention may have dimensions of 4 mm×2 mm.

The sustained release delivery apparatus may take the form of a covered rod or dispersed matrix structure. Such a multi mini-pellet system permits the treatment of diseases over an extended period with pharmaceutically active components which have heretofore not been applicable to such diseases as it has not been possible to achieve the required threshold blood plasma levels to be efficacious and to maintain those blood levels over an extended period of time.

Preferably the sustained release delivery apparatus may provide approximately zero order release of pharmaceutical active.

For example, in veterinary applications, the pharmaceutically active component ivermectin is a mixture of not less than 90% ivermectin H₂B₁a and not more than 5% ivermectin H₂B₁b having the respective molecular weights 875.10 and 861.07. Ivermectin is a potent macrocyclic lactone disaccharide antiparasitic agent used to prevent and treat parasite infestations in animals. The compound has activity against both internal and external parasites as well as being effective against arthropods, insects, nematodes, filarioidea, platyhelminths and protozoa.

The sustained release support material may take the form of a support matrix or rod, preferably a covered rod structure.

The sustained release support material may be formed from a biodegradable or biocompatible material, preferably a biocompatible hydrophobic material. The biocompatible material may be selected from the group consisting of polyesters, polyamino acids, silicones, ethylene-vinyl acetate copolymers and polyvinyl alcohols. Preferably the sustained release support material is a silicone material. A silicone rod is preferred. The silicone material may be a porous silicon or Biosilicon material, for example as described in International patent application PCT/GB99/01185, the entire disclosure of which is incorporated herein by reference. A mesoporous, microporous or polycrystalline silicon or mixtures thereof may be used.

Biodegradable polymers that may be employed in the present invention may be exemplified by, but not limited to, polyesters such as poly(lactic acid-glycolic acid) copolymers (PLGA), etc. and by hydrophobic polyamino acids such as polyaranin, polyleucine, polyanhydride, poly(glycerol-sebacate)(PGS), Biopol and the like. The hydrophobic polyamino acids mean polymers prepared from hydrophobic amino acids.

Nonbiodegradable polymers that may be employed in the present invention may be exemplified by, but not limited to, silicones, polytetrafluoroethylenes, polyethylenes, polypropylenes, polyurethanes, polyacrylates, polymethacrylates such as polymethylmethacrylates, etc., ethylene-vinyl acetate copolymers, and others. More preferably a silicone elastomer as described in copending Australian provisional patent application PR7614, to applicants (the entire disclosure of which is incorporated herein by reference), may be used.

The anti-parasitic composition, as described above may, in a preferred embodiment, further include at least one pharmaceutically active component. The pharmaceutically active component may be exemplified by, but not limited to, one or more selected from the group consisting of:

| | |
|---|---|
| Analgesics | Anti-arthritic |
| Anti-convulsivants | Anti-fungals |
| Anti-histamine | Anti-infectives |
| Anti-inflammatories | Anti-microbials |
| Anti-protozoals | Antiviral pharmaceuticals |
| Contraceptives | Growth promoters |
| Hematinics | Hemostatics |
| Hormones and analogs | Immunostimulants |
| Minerals | Muscle relaxants |
| Vaccines and adjuvants | Vitamins |

The pharmaceutically active component may include a water-insoluble pharmaceutical, a water-soluble pharmaceutical or mixtures thereof.

The water-soluble pharmaceutical actives useful in the sustained release delivery apparatus according to the present invention include such drugs as peptides, proteins, glycoproteins, polysaccharides, and nucleic acids.

The present invention is particularly appropriate for delivery of pharmaceuticals, in addition to parasitic agents, that are very active even in extremely small quantities and whose sustained long-term administration is sought. When used in substantially increased quantities, such pharmaceuticals may be applied to disease indications heretofore untreatable over an extended period. The pharmaceuticals may be exemplified by, but not limited to, one or more selected from the group consisting of cytokines (eg. interferons- and interleukins), hematopoietic factors (eg. colony-stimulating factors and erythropoietin), hormones (eg. growth hormone, growth hormone releasing factor, calcitonin, leuteinizing hormone, leuteinizing hormone releasing hormone, and insulin), growth factors (eg. somatomedin, nerve growth factor), neurotrophic factors, fibroblast growth factor, and hepatocyte proliferation factor, cell adhesion factors; immunosuppressants; enzymes (eg. asparaginase, superoxide dismutase, tissue plasminogen activating factor, urokinase, and prourokinase), blood coagulating factors (eg. blood coagulating factor VIII), proteins involved in bone metabolism (eg. BMP (bone morphogenetic protein)), and antibodies.

The interferons may include alpha, beta, gamma, or any other interferons or any combination thereof. Likewise, the interleukin may be IL-1, IL-2, IL-3, or any others, and the colony-stimulating factor may be multi-CSF (multipotential CSF), GM-CSF (granulocyte-macrophage CSF), G-CSF (granulocyte CSF), M-CSF (macrophage CSF), or any others.

Vaccines are particularly preferred. The vaccines useful in the sustained release delivery apparatus according to the present invention may be exemplified by, but not limited to, one or more selected from the group consisting of

| | |
|---|---|
| Adenovirus | Anthrax |
| BCG | Chiamydia |
| Cholera | Circovirus |
| Classical swine fever | Coronavirus |
| Diphtheria-Tetanus (DT for children) | Diphtheria-Tetanus (tD for adults) |
| Distemper virus | DTaP |
| DTP | E coli |
| Eimeria (coccidosis) | Feline immunodeficiency virus |
| Feline leukemia virus | Foot and mouth disease |
| Hemophilus | Hepatitis A |
| Hepatitis B | Hepatitis B/Hib |
| Herpes virus | Hib |
| Influenza | Japanese Encephalitis |
| Lyme disease | Measles |
| Measles-Rubella | Meningococcal |
| MMR | Mumps |
| Mycoplasma | Para influenza virus |
| Parvovirus | Pasteurella |
| Pertussis | Pestivirus |
| Plague | Pneumococcal |
| Polio (IPV) | Polio (OPV) |
| Pseudorabies | Rabies |
| Respiratory syncitial virus | Rotavirus |
| Rubella | Salmonella |
| Tetanus | Typhoid |
| Varicella | Yellow Fever |

For example, in veterinary applications for control of parasitic infections, a combination of ivermectin and praziquantel or a combination of zeranol and trembolone may be used.

As stated above, the anti-parasitic composition according to the present invention further includes a carrier for the anti-parasitic agent component.

The carrier may be selected to permit release of the pharmaceutically active component over an extended period of time from the composition.

The carrier may include a water-soluble substance.

A water-soluble substance is a substance which plays a role of controlling infiltration of water into the inside of the drug dispersion. There is no restriction in terms of the water-soluble substance so long as it is in a solid state (as a form of a preparation) at the body temperature of an animal or human being to which it is to be administered, and a physiologically acceptable, water-soluble substance.

One water-soluble substance, or a combination of two or more water-soluble substances may be used. The water-soluble substance specifically may be selected from one or more of the group consisting of synthetic polymers (eg. polyethylene glycol, polyethylene polypropylene glycol), sugars (eg. sucrose, mannitol, glucose, sodium chondroitin sulfate), polysaccharides (e.g. dextran), amino acids (eg. glycine and alanine), mineral salts (eg. sodium chloride), organic salts (eg. sodium citrate) and proteins (eg. gelatin and collagen and mixtures thereof).

In addition, when the water-soluble substance is an amphipathic substance, which dissolves in both an organic solvent and water, it has an effect of controlling the release of, for example, a lipophilic drug by altering the solubility thereof. An amphipathic substance includes, but not limited to, polyethylene glycol or a derivative thereof, polyoxyethylene polyoxypropylene glycol or a derivative thereof, fatty acid ester and sodium alkylsulfate of sugars, and more specifically, polyethylene glycol, polyoxy stearate 40, polyoxyethylene[196]polyoxypropylene-[67]glycol, polyoxyethylene[105]polyoxypropylene[5]glycol, polyoxyethylene-[160]polyoxypropylene[30]glycol, sucrose esters of fatty acids, sodium lauryl sulfate, sodium oleate, sodium desoxycholic acid (sodium deoxycholic acid (DCA)) of which mean molecular weights are more than 1500.

Polyoxyethylene polyoxypropyleneglycol, sucrose, or a mixture of sucrose and sodium deoxycholic acid (DCA) are preferred.

In addition, the water-soluble substance may include a substance which is water-soluble and has any activity in vivo such as low molecular weight drugs, peptides, proteins, glycoproteins, polysaccharides, or an antigenic substance used as vaccines, i.e. water-soluble drugs.

The pharmaceutical carrier may constitute from approximately 5% to 30% by weight, preferably approximately 10% to 20% by weight based on the total weight of the pharmaceutically active composition.

Each sustained release implant or mini-pellet may include additional carriers or excipients, lubricants, fillers, plasticisers, binding agent, pigments and stabilising agents.

Suitable fillers may be selected from the group consisting of talc, titanium dioxide, starch, kaolin, cellulose (microcrystalline or powdered) and mixtures thereof.

Suitable binding agents include polyvinyl pyrrolidine, hydroxypropyl cellulose and hydroxypropyl methyl cellulose and mixtures thereof.

The sustained release implant according to the present invention may have a rod-like shape, for example it is selected from circular cylinders, prisms, and elliptical cylinders. When the device is administered using an injector-type instrument, a circular cylindrical device is preferred since the injector body and the injection needle typically have a circular cylindrical shape.

The sustained release implant according to the present invention may be manufactured according to the method described in copending Australian provisional patent application PR7614 referred to above.

The inner layer of the pharmaceutical formulation of the present invention, viewed in right section, may contain two or more layers containing different anti-parasitic agents and/or pharmaceuticals. These layers may take the form of concentric circles with a single center of gravity or may appear as a plural number of inner layers whose respective centers of gravity lie at different points in the cross section. When the formulation contains more than one inner layer there may be one or more anti-parasitic agents or pharmaceuticals present in the inner layers. For example, the actives may be present such that each layer contains a different active or there is more than one active in one or all of the inner layers.

The size of the sustained release anti-parasitic formulation of the present invention may, in the case of subcutaneous administration, be relatively small, e.g. ¼ to 1/10 normal size. For example using an injector-type instrument, the configuration may be circular cylindrical, and the cross-sectional diameter in the case is preferably 0.2 to 4 mm, the axial length being preferably approximately 0.2 to 30 mm, preferably approximately 0.5 to 15 mm, more preferably approximately 1 to 10 mm.

The thickness of the outer layer should be selected as a function of the material properties and the desired release rate. The outer layer thickness is not critical as long as the specified functions of the outer layer are fulfilled. The outer layer thickness is preferably 0.05 mm to 3 mm, more preferably 0.05 mm to 0.25 mm, and even more preferably 0.05 mm to 0.1 mm.

Sustained release implants according to the present invention may preferably have a double-layer structure, in order to achieve long-term zero-order release.

Where a double-layer structure is used, the anti-parasitic-containing inner layer and the water-impermeable outer layer may be fabricated separately or simultaneously. A circular cylindrical sustained release apparatus with a single centre of gravity in the device cross section may be fabricated, for example, by the following methods:

(1) initial fabrication of a rod-shaped inner layer followed by coating the rod with a liquid containing dissolved outer layer material and drying;

(2) insertion of a separately fabricated inner layer into a tube fabricated from outer layer material; or

(3) simultaneous extrusion and molding of the inner and outer layers using a nozzle.

However, the fabrication method is not limited to these examples. When a water-impermeable outer layer cannot be obtained in a single operation, it will then be necessary, for example, to repeat the outer layer fabrication process until water permeation can be prevented. In any case, the resulting composition is subsequently cut into suitable lengths. Successive cutting yields a sustained release apparatus according to the present invention having both ends open.

An anti-parasitic formulation with an open end at one terminal may be fabricated by dipping one terminal of the anti-parasitic formulation into a solution which dissolves the outer-layer material and drying it, or by covering one terminal end of the anti-parasitic formulation with a cap made from the outer-layer material. In addition, the fabrication may comprise insertion of the inner layer into an outer-layer casing with a closed-end at one terminal, which are separately produced, and also formation of the inner layer in said casing.

In a further aspect of the present invention there is provided a method for the therapeutic or prophylactic treatment of a parasitic condition in an animal (including a human) requiring such treatment, which method includes administering to the animal a sustained release delivery apparatus including a plurality of sustained release mini-implants or pellets;

each implant including

the anti-parasitic composition including

at least one anti-parasitic agent; and

a carrier therefor; and optionally a sustained release support material; and

the anti-parasitic composition carried in or on the sustained release support material, when present;

each implant being of insufficient size individually to provide a predetermined desired threshold blood level of anti-parasitic active for treatment of a selected disease indication.

As stated above, it has been found that the pharmaceutical payload may be increased by the sustained release delivery apparatus according to the present invention when compared to the prior art. Infestations and diseases which were therefore untreatable may now be treated over an extended period of time utilising the apparatus of the present invention. For example, treatment with ivermectin in dogs may result in protection levels, e.g against fleas and endoparasites such as worms for up to an entire season (e.g. three to six months), with protection against heartworm for up to 12 months.

For example, in animals suffering from parasitic infections such as fleas or ticks, the animals may be treated utilising the sustained release delivery apparatus including an anti-parasitic drug such a ivermectin. As stated above, it was not possible to achieve a required blood concentration threshold to permit treatment of such a parasitic disease utilising a sustained release approach as the required blood concentration threshold could not be achieved utilising such a mechanism.

The method of administration may include subcutaneous or intramuscular injection, intradermal injection, intraperitoneal injection, intranasal insertion or indwelling, intrarectal insertion or indwelling, for example as a suppository or utilising oral administration.

The animals to be treated may be selected from the group consisting of sheep, cattle, horses, pigs, goats, dogs, cats, ferrets, rodents, including mice and rats, birds, including chicken, geese and turkeys, marsupials, fish, primates and reptiles.

The method according to the present invention is particularly applicable to larger animals, e.g. cattle, sheep, pigs, dogs, cats and humans where high dosage levels are required to achieve the prerequisite threshold pharmaceutical active blood levels for successful treatment of selected disease and/or parasitic indications.

Preferably, each mini implant takes the form of a compressed tablet or extruded rod bearing a silicone coating thereover.

More preferably each mini implant is approximately 0.1 to 0.5 times the length and/or diameter of a standard full size tablet.

In a preferred embodiment, the method further includes

providing a sustained release kit including

a plurality of sustained release mini implants or pellets packaged for delivery in a single treatment;

each mini-implant or pellet including

an anti-parasitic composition including

at least one pharmaceutically active component including an anti-parasitic agent;

a carrier therefor; and optionally

a sustained release support material; the anti-parasitic composition carried in or on the sustained release support material;

each implant being of insufficient size individually to provide a predetermined desired threshold blood level of anti-parasitic agent for treatment of external parasites; and

administering the mini implants or pellets in a single treatment.

Preferably the plurality of sustained release mini implants or pellets are provided in a biodegradable sheath and administered as a single cartridge via an injector instrument.

The present invention will now be more fully described with reference to the accompanying examples. It should be understood, however, that the description following is illustrative only and should not be taken in anyway as a restriction on the generality of the invention described above.

### EXAMPLE 1

A mixture of ivermectin and carrier material in proportions specified in Table 1 below was produced. The obtained solid was milled and passed through a sieve (212 μm). A portion of a powder thus obtained and Silastic™ Medical Grade ETR Elastomer Q7-4750 Component A and Silastic™ Medical Grade ETR Elastomer Q7-4750 component B were mixed to give a drug dispersion component. Silastic™ Medical Grade ETR Elastomer Q7-4750 Component A and Silastic™ Medical Grade ETR Elastomer Q7-4750 Component B were mixed to give a coating layer component. Thus obtained drug dispersion component and coating layer component were molded by extruding from a double extruder which enables them to be molded by extruding so that the drug dispersion is concentrically coated with the coating layer, and was allowed to stand at room temperature to cure, which was cut to obtain the cylindrical preparation 1 (the length of the preparation is 500 mm, the diameter of the preparation is 1.5 mm).

The cylindrical preparation 1 is then cut into various lengths as shown in Table 1 to provide the sustained release mini-pellets according to the present invention.

Examination 1

Preparation 1 was subcutaneously administered to dogs, whole blood was collected from the animal via the jugular vein and the dogs periodically challenged with fleas.

Results are shown in Tables 1 and 2.

TABLE 1

| Implant | | | | Bleed (weeks) | | | | | | |
|---|---|---|---|---|---|---|---|---|---|---|
| 30% (80% IVM, 13% | | | | | | | Flea | | Flea | |
| DOC, 7% sucrose) | | Total | Length | No. | | | Challenge | | Challenge | |
| 70% silicone | Dose | length cm | combinations | Dogs | 0 | 2 | 2 weeks | 4 | 4 weeks | 6 |
| | 18.8 mg | 4.8 cm | 2 × 1.2, 12 × | 3 | √ | √ | √ | √ | √ | √ |
| | | | 0.2 | | | | | | | |
| | 9.4 mg | 2.4 cm | 1 × 1.2, 6 × 0.2 | 3 | √ | √ | √ | √ | √ | √ |
| | 9.4 mg | 2.4 cm | 2 × 0.6, 6 × 0.2 | 3 | √ | √ | √ | √ | √ | √ |
| | 4.7 mg | 1.2 cm | 6 × 0.2 | 3 | √ | √ | √ | √ | √ | √ |
| | | 0 | 0 | 3 | √ | √ | √ | √ | √ | √ |

All dogs not to be treated with Revolution/ivermectin or any other anti-parasitic

TABLE 2
(Results at 4 weeks)

| | | | | | Number of fleas | |
|---|---|---|---|---|---|---|
| | | | | Number of | collected at 48 hours | % Reduction in |
| Group No. | Sample No. | Breed | Sex | fleas applied | after administration | flea burden |
| 1 | 1 | Labrador | F | 99 | 4 | 75% |
| | 2 | Beagle | F | 95 | 8 | 75% |
| | 3 | Labrador | F | 82 | 11 | 75% |
| 2 | 4 | Labrador | F | 98 | 0 | 79.5% |
| | 5 | Beagle | F | 45 | 18 | 79.5% |
| | 6 | Labrador | F | 99 | 1 | 79.5% |
| 3 | 7 | Beagle | F | 100 | 17 | 55.4% |
| | 8 | Labrador | F | 97 | 24 | 55.4% |
| | 9 | Labrador | F | 96 | 0 | 55.4% |
| 4 | 10 | Beagle | M | 99 | 18 | 67.4% |
| | 11 | Labrador | F | 97 | 12 | 67.4% |
| | 12 | Labrador | F | 80 | 0 | 67.4% |
| 5 | 13 | Beagle | F | 80 | 37 | 0 |
| | 14 | Labrador | F | 100 | 23 | 0 |
| | 15 | Labrador | F | 96 | 32 | 0 |

$\% Reduction = \frac{mean count ( controls ) - mean count ( treated ) \times 100}{mean count ( controls )}$

It will be understood that the invention disclosed and defined in this specification extends to all alternative combinations of two or more of the individual features mentioned or evident from the text or drawings. All of these different combinations constitute various alternative aspects of the invention.

It will also be understood that the term “comprises” (or its grammatical variants) as used in this specification is equivalent to the term “includes” and should not be taken as excluding the presence of other elements or features.

1-39. (cancelled).

40. Use of an anti-parasitic agent in a sustained release form in the treatment of ectoparasitic infections, wherein the anti-parasitic agent is provided in a sustained release apparatus including a plurality of sustained release mini-implants or pellets, each mini-implant or pellet including
an anti-parasitic active containing inner layer; and
a water-impermeable outer layer;
each implant being of insufficient size individually to provide a predetermined desired threshold blood level of anti-parasitic active for protection against ectoparasitic infections;
the sustained release apparatus providing, in use, zero order release of anti-parasitic active at, without reaching harmful toxic levels.

41. Use according to claim 40, wherein the anti-parasitic agent includes a macrocyclic lactone or insect growth regulator, or mixtures thereof.

42. Use according to claim 41, wherein the macrocyclic lactone is selected from one or more of the group consisting of ivermectin, moxidectin, eprinomectin and doramectin.

43. Use according to claim 40, wherein the anti-parasitic agent in a sustained release form provides protection concomitantly against ectoparasitic and endoparasitic infections.

44. Use according to claim 43, wherein the anti-parasitic agent includes ivermectin and provides for the concomitant treatment of ectoparasites and endoparasites.

45. Use according to claim 40, wherein the animal to be treated is a domestic or farm animal selected from the group consisting of sheep, cattle, horses, pigs, goats, dogs, cats, ferrets, rodents, including mice and rats, birds, including chicken, geese and turkeys, marsupials, fish, primates and reptiles.

46. Use according to claim 40, wherein each mini-implant takes the form of an extruded rod bearing a water-impermeable coating thereover.

47. Use according to claim 43, wherein the mini-implants or pellets are provided
in a first size which provides a blood level of pharmaceutical active of approximately 1.25 to 3 times the desired threshold blood level for a first relatively short time period; and
in a second size which provides a blood level of pharmaceutical active at or near the desired threshold blood level for a second longer time period.

48. A method for the therapeutic or prophylactic treatment of a parasitic condition in an animal (including a human) requiring such treatment, which method includes administering to the animal a sustained release delivery apparatus including a plurality of sustained release mini-implants or pellets;
each mini implant or pellet including
an anti-parasitic active containing inner layer; and
a water-impermeable outer layer;
each implant being of insufficient size individually to provide a predetermined desired threshold blood level of anti-parasitic active for protection against ectoparasitic infections;
the sustained release apparatus providing, in use, zero order release of anti-parasitic active at, without reaching harmful toxic levels; and
administering the sustained release delivery apparatus to the animal to be treated.

49. A method according to claim 48, wherein each mini-implant takes the form of an extruded rod bearing a water-impermeable coating thereover.

50. A method according to claim 48, wherein the mini-implants or pellets are provided in at least two different sizes and provides for the concomitant treatment of ectoparasites and endoparasites.

51. A method according to claim 48, where the mini-implants or pellets are provided
in a first size which provides a blood level of pharmaceutical active of approximately 1.25 to 3 times the desired threshold blood level for a first relatively short time period; and
in a second size which provides a blood level of pharmaceutical active at or near the desired threshold blood level for a second longer time period.

52. A method according to claim 48, wherein the animal to be treated is selected from the group consisting of sheep, cattle, horses, pigs, goats, dogs, cats, ferrets, rodents, including mice and rats, birds, including chicken, geese and turkeys, marsupials, fish, primates and reptiles.

53. A method according to claim 52, wherein the sustained release delivery apparatus is administered via subcutaneous or intramuscular injection, intranasal insertion or indwelling, intrarectal insertion or indwelling, or oral administration.

54. A method according to claim 48, wherein the anti-parasitic agent includes a macrocyclic lactone, or an insect growth regulator, or mixtures thereof.

55. A method according to claim 54, wherein the anti-parasitic agent includes a macrocyclic lactone selected from one or more of the group consisting of ivermectin, moxidectin, eprinomectin and doramectin.

56. A method according to claim 55, wherein the anti-parasitic composition further includes a pharmaceutically active component selected from one or more of the group consisting of cytokines, hematopoietic factors, hormones, growth factors, neurotrophic factors, fibroblast growth factor, and hepatocyte proliferation factor; cell adhesion factors;
immunosuppressants; enzymes, blood coagulating factors, proteins involved in bone metabolism, vaccines and antibodies.

57. A method according to claim 48, which method further includes
providing a sustained release kit including
a plurality of sustained release mini implants or pellets packaged for delivery in a single treatment;
each mini-implant or pellet including
an anti-parasitic active containing inner layer; and
a water-impermeable outer layer;
each implant being of insufficient size individually to provide a predetermined desired threshold blood level of anti-parasitic active for protection against ectoparasitic infections;
the sustained release apparatus providing, in use, zero order release of anti-parasitic active at, without reaching harmful toxic levels; and
administering the mini implants or pellets in a single treatment.

58. A method according to claim 57, wherein each mini-implant or pellets provides for the concomitant treatment of ectoparasites and endoparasites and is provided in a first size which provides a blood level of pharmaceutical active of approximately 1.25 to 3 times the desired threshold blood level for a first relatively short time period; and
in a second size which provides a blood level of pharmaceutical active at or near the desired threshold blood level for a second longer time period.

59. A method according to claim 57, wherein the plurality of sustained release mini implants or pellets are provided in a biodegradable sheath and administered as a single cartridge via an injector instrument.
